(19) United States
(12) Patent Application Publication
(10) Pub. No.: US 2016/0192573 A1
(43) Pub. Date: Jul. 7, 2016

(54) Counter - Rotating Cultivation Device

(71) Applicant: Rolf MATTSON, UMEÅ (SE)

(72) Inventor: Rolf Mattson, Umeå (SE)

(73) Assignee: Rolf Mattson, Umeå (SE)

(21) Appl. No.: 14/915,471

(22) PCT Filed: Jul. 18, 2013
(86) PCT No.: PCT/SE2013/000115

§ 371 Date: Feb. 29, 2016

(30) Foreign Application Priority Data
Aug. 31, 2012 (SE) 1200527-8

(51) Int. Cl. A01B 33/02; F16H 1/22; A01B 33/08; A01B 1/06

(52) U.S. Cl. CPC A01B 33/027; A01B 1/065; F16H 1/222; A01B 33/082

(57) ABSTRACT

The present invention relates to a counter-rotating cultivation device (1) including at least one input drive axel (2) which transfer rotational force via at least one first output axle (5) and at least one second output axle. A specific feature of the present counter-rotating cultivation device is that the second output axle's (6) direction of rotation is opposite in relation to the first output axle's (5) direction of rotation.

### FIELD OF THE INVENTION

The present invention concerns a counter-rotating cultivation device intended for use as, for example, a hand-held cultivator, in accordance with the claims.

### BACKGROUND OF THE INVENTION

In several different areas, there exists a need to mix, blend or break up material. Such a need is present, for example in connection with horticulture (gardening) and other similar work where for example soil and the like are mixed (cultivated) in conjunction with loosening of the soil and the removal of weeds.

Equipment intended to be used to cultivate (mix) soil and the like are already known in several different varieties and sizes. For example, several different types of rotating tillers/cultivators have been developed, everything from relatively large tillers/cultivators, which are powered by internal combustion engines, to relatively small hand-held types of cultivators, which are powered by electric motors.

One problem with known types of hand-held cultivating/tilling devices, whose cultivating tools (implements) during use rotate around an essentially horizontal axle, is that they tend to move in an undesired direction such as for example away from or toward the user of the cultivating device. This means that the user must hold back the cultivating device which may be strenuous for the user. Especially for older, younger or muscularly weak people or persons with some type of physical handicap, existing hand-held tilling/cultivating devices may be difficult to operate.

Known types of hand-held tilling/cultivating devices even have other design flaws. Current designs make it for example difficult to work the soil where space is limited, such as for example around bushes. There is also a problem if the hand-held cultivating device's handles and the like are not adaptable for right and left handed users.

The need to mix materials is also present in several other areas. There also exist problems with mixing materials, and/or stirring materials or fluids in other areas. For example, problems exist when paint, concrete and other types of materials are to be mixed. The fact that current devices usually have mixing tools (implements) that rotate in the same direction, causes motion energy to occur that wants to propel the device in some direction, which most often does not favor either the mixing (blending) operation or the user's working conditions.

### PRIOR ART

Designs which are intended to be used to stir, mix or loosen materials in gardens and the like are previously known in numerous different variants. For example, GB 1467252 describes a variant of an electrically driven cultivator (tilling device). The cultivator is comprised of a motor unit which, via an axle and a gear drives one first cultivating tool (tine implement) and one second tool. The cultivator differs substantially from the design according to the present patent application. For example, the cultivating tools are not counter-rotating which allows the tools during use to pull (push, drag) in some direction.

U.S. Pat. No. 5,850,882 describes a hand-held gardening cultivator. The hand-held gardening cultivator utilizes rechargeable batteries to power itself. The design includes a drive axle which via a gear transfers a rotational force to one first cultivating tool and to one second cultivating tool. The cultivator differs substantially from the design according to the present patent application. For example, the cultivating tools are not counter-rotating relative one another, which results in the cultivating tools pulling the cultivator in a forward direction during use.

U.S. Pat. No. 2,823,597 describes a hand-held cultivator. The hand-held cultivator includes a drive axle which via a gear transfers a rotational force to one first cultivating tool and to one second cultivating tool. The cultivator differs substantially from the design according to the present patent application. For example, the cultivating tools are not counter-rotating which results in the cultivating tools pulling the hand-held cultivator in some direction.

DE1800229 describes a hand-carried cultivator intended to be used for soil cultivation. The hand-carried cultivator is driven by an electric drill or the like. The design differs substantially from the design according to the present patent application. For example, the cultivator's cultivating tools are not counter-rotating relative one another.

US20030066663 describes a hand-held rotating device intended to be used for example for removal of weeds and the like. The design includes a rotary axle which in its upper end is connected to a drill and in its lower end is equipped with cultivating tools. Even this design differs substantially from the design according to the present patent application. For example, the design does not include counter-rotating cultivating tools.

### BRIEF DESCRIPTION OF THE DRAWINGS

In the following detailed description of the present invention, reference and references to the following figures will occur. The figures are briefly described in the following figure list.

FIG. 1 shows schematically a counter-rotating cultivation device in accordance with the present patent application.

FIG. 2 shows the angle of a cultivation tool.

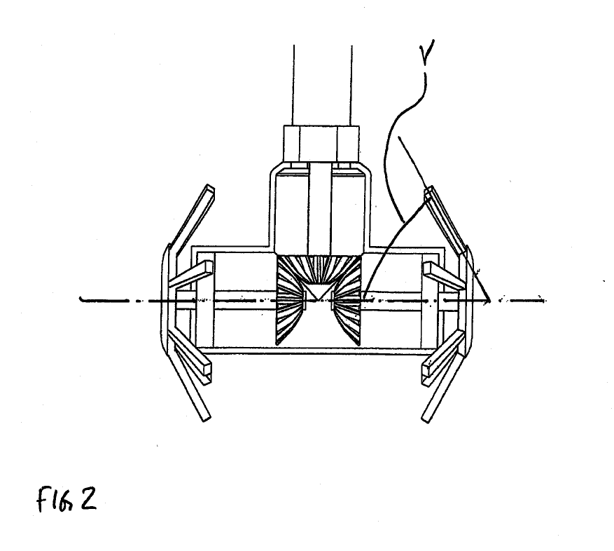

### DETAILED DESCRIPTION OF THE INVENTION

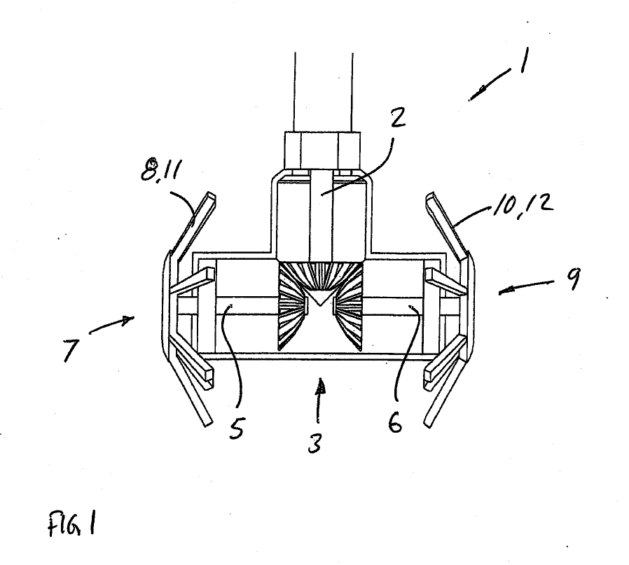

With reference to FIG. 1, a counter-rotating cultivation device 1 is schematically shown, which is intended to transfer rotational force from one drive unit to at least one first and one second cultivation tool or the like, in accordance with the present patent application. The counter-rotating cultivation device may be used in applications where the drive unit and the counter-rotating cultivation device are integrated into one unit. The counter-rotating cultivation device may even be used in applications where the drive unit and the counter-rotating cultivation device are comprised of separate units which may be connected together and disconnected.

In one preferred embodiment of the present counter-rotating cultivation device, the device is intended to be used in a hand-carried (hand-held) cultivating device (not shown in its entirety in the figures). In alternative embodiments the counter-rotating cultivation device 1 may be used in other applications, such as in devices intended for mixing or blending of materials and fluids.

The counter-rotating cultivation device 1 includes at least one input axle (shaft) 2. The input axle 2 is preferably driven by a drive unit (not shown in the figures). The counter-rotating cultivation device's 1 input axle 2 drives via a gear 3, completely or partially enclosed in a gearbox 4 or similar, at least one first output axle (shaft) 5 and at least one second output axle (shaft) 6. The first output axle 5 includes at least one connector 7, connecting member or similar for at least one cultivation tool 8. The second output axle 6 includes at least one connector 9, connecting member or similar for at least one second cultivation tool 10. The cultivation tool 8 in the exemplifying embodiment is comprised of at least one first cultivating implement 11. Cultivation tool 8 and cultivation tool 10 may be comprised of other types of tools, devices and the like intended for mixing, blending and/or stirring material and/or fluids.

The gear 3 of the exemplifying embodiment includes an input axle 2, a first output axle 5 and a second output axle 6. The output axles' 5 and 6 rotation axes are preferably directed in the latitudinal direction in relation to the input axle's rotation axis. In the exemplifying embodiment, the first output axle's 5 and the second output axle's 6 rotation axes coincide essentially with each other in a common rotation axis. A unique feature of the present design is that the gear's 3 design allows for the first output axle 5 and the second output axle 6 to rotate in opposite directions in relation to one another.

In one exemplifying embodiment the first output axle's 5 rotation axis and the second output axle's 6 rotation axis essentially coincide with each other in the output axles' 5 and 6 axial directions. In alternative embodiments, the first output axle's 5 rotation axis and the second output axle's 6 rotation axis are divergent or essentially divergent from each other in the output axles' 5 and 6 axial directions.

In one preferred embodiment of the cultivation device 1, according to the present patent application, a first cultivating implement 11 is connected to the first output axle 5 and a second cultivating implement 12 is connected to the second output axle 6. Cultivating implements 11 and 12 may have a plurality of different shapes. In the exemplifying embodiment, cultivating implements 11 and 12 have a shape which likens (brings to mind) a truncated cone, where the section of the truncated cone with the lesser diameter is connected to the output axle. The angle between each respective implements' rotation axis and the projecting sections (that form the shape of a truncated cone) lie preferably within an interval of 30 to 45 degrees. The shown embodiment is not limiting for the scope of protection, for example the angle V in alternative embodiments may differ from the given interval. Furthermore, the counter-rotating cultivation device's design (form, shape) and the design of the implement's protruding parts (tines or similar) as well as the number of protruding parts may differ from the ones shown in the figures.

It is conceivable that the present counter-rotating cultivation device 1 be defined in another manner. It is for example conceivable that the present invention be defined as cultivation implement (head) for a hand-held tiller/cultivator. The counter-rotating cultivation device may even be used in other areas such as some type of device intended to be used for example to mix paint, concrete as well as several other types of materials and fluids.

In the detailed description of the present invention, design details may have been omitted which are apparent to persons skilled in the art of the field concerning the method and device. For example, the design includes bearings and several more components of a type suitable for the purpose. Such obvious design details are included to the extent necessary so that the proper and full performance of the present invention is achieved.

Even if certain preferred embodiments have been described in detail, variants and modifications of the method and device may become apparent for specialists in the field of the invention. All such modifications and variants are regarded as falling within the scope of the following claims.

### EXEMPLIFYING ADVANTAGES OF THE PRESENT INVENTION

A number of advantages are achieved with the present invention. Firstly, a cultivation device is achieved that has a counter-rotating rotational movement which enables the device to a lesser extent than known designs to pull or push itself in an undesired direction. Another advantage of the design is that muscularly weak people are able to more easily operate the cultivation device during the process of mixing (tilling) materials. A further advantage is that the device provides for very good accessibility in regards to the mixing (tilling) of soil around bushes and the like. A still further advantage of the design is that it may easily be adapted to both left and right handed users. A yet further advantage of the design is that the mixing (tilling) process is more efficient and this also reduces the user's work effort, which in turn may also reduce work-related injuries.

1. Hand-held counter-rotating cultivation device (1) comprised of at least one input drive axle (2) which may be connected to and disconnected from at least one separate drive unit, said input drive axle (2) transfers rotational force via at least one gear (3) to at least one first output axle (5) and at least one second output axle (6) characterized in that the first output axle's (5) rotation axis and the second output axle's (6) rotation axis coincide essentially with each other in the output axles' axial directions and that the second output axle's (6) direction of rotation is opposite in relation to the first output axle's (5) direction of rotation and that the counter-rotating cultivation device (1) includes at least one first cultivation tool (8) connected to the first output axle (5) and at least one second cultivation tool (10) which is connected to the second output axle (6), said first cultivation tool (8) is comprised of a first cultivating implement (11) in the form of a truncated cone with the cone's lesser diameter connected to the first output axle (5) and that the second cultivation tool (10) is comprised of a second cultivating implement (12) in the form of a truncated cone with the cone's lesser diameter connected to the second output axle (6).

2. Counter-rotating cultivation device (1) in accordance with claim 1 characterized in that the cultivating implements' (11, 12) cone shape has an angle within an interval of 30 to 45 degrees.

3. Counter-rotating cultivation device (1) in accordance with claims 1 and 2 characterized in that the cultivating implements' (11, 12) have protruding parts.

4. Counter-rotating cultivation device (1) in accordance with claim 1 characterized in that the cultivating implements' (11, 12) cone shape has a larger diameter in the direction towards the gear (3).

5. Counter-rotating cultivation device (1) in accordance with claim 1 characterized in that the gear (3) is, completely or partially, enclosed in a gear box.
